(19) United States
(12) Patent Application Publication
(10) Pub. No.: US 2004/0255735 A1
(43) Pub. Date: Dec. 23, 2004

(54) Method and apparatus for removing sprinkler head from polymer conduit in suspended ceiling

(76) Inventors: Philip M. Sahag, Scottsdale, AZ (US); John A. Fraser, Palm Springs, CA (US)

Correspondence Address: TOD R. NISSLE, P.C., P.O. Box 55630, Phoenix, AZ, 85078, US

(21) Appl. No.: 10/428,323

(22) Filed: Apr. 30, 2003

(51) Int. Cl. B25B 23/159

(52) U.S. Cl. 81/477

(57) ABSTRACT

A method and apparatus facilitate the removal of a fire sprinkler head extending into an opening formed in the ceiling. The apparatus includes a pliable belt that engages the conduit leading to the fire sprinkler head such that damage to the ceiling is minimized or eliminated. The belt is mounted on the end of a handle that extends up into the ceiling. The handle does not have to be tilted when it is used to wrap the belt around the conduit. Avoiding the canting of the handle minimizes the probability that the ceiling will be damaged during use of the apparatus.

This invention pertains to fire sprinkler systems.

More particularly, the invention pertains to a method and apparatus to facilitate the removal of a fire sprinkler head extending into an opening formed in the ceiling of a building structure.

As is illustrated in FIG. 9, a conventional fire sprinkler system includes a hollow cylindrical conduit 17, and a cylindrical cap 24 that fits over and is secured to the distal end of the conduit. The cap 24 includes a hex-nut member 27 having a six-sided outer peripheral surface and having an internally threaded opening 27A extending into member 27. In many cases, conduit 17 and cap 24 are fabricated from CPVC (chlorinated polyvinyl chloride), a polymer or plastic. Member 27 is typically fabricated from metal and is permanently connected to cap 24 with adhesive or other desired means. The shape and dimension and construction of conduit 17, cap 24, etc. can be varied as desired. For example, conduit 17 can consist of metal pipe that is internally threaded at the distal end of the metal pipe. Such a construction would obviate the need for cap 24 and member 27.

Conduit 17 is connected to a water supply system that preferably continuously maintains water under pressure in conduit 17.

A conventional fire sprinkler system also includes a sprinkler head 18 that includes externally threaded upper end 28. End 28 is shaped and dimensioned to be threaded into internally threaded opening 27A by turning end 28 in the direction of arrow E (or, if desired, in the opposite direction depending on the thread design) into opening 27A to move head 18 upwardly in the direction of arrow F. Head 18 also includes a skirt 32. Skirt 32 is typically, but not necessarily, the component of head 18 having the greatest width W, as indicated in FIG. 9. Skirt 32 functions as a spacer that enables an individual to center head 18 with respect to the inner peripheral edge 22 of an opening formed through drywall, sound tiles, or other material comprising a ceiling or wall. Skirt 32 also tends to protect head 18 because it is more likely that an object striking head 18 will contact skirt 32 instead of striking other more sensitive components of head 18. The mechanism that “opens” head 18 and permits water from conduit 17 to flow under pressure through the head 18 can vary as desired. Typically, however, a hollow piece of glass 34 is positioned in head 18. The glass 34 contains a liquid that expands when the liquid is heated. Another function of skirt 32 is to facilitate the conduction of heat to glass 34. When the liquid is heated to a sufficient temperature, the expansion of the liquid causes glass 34 to break. Breakage of glass 34 opens a valve in head 18 that permits pressurized liquid from conduit 17 to flow outer through head 18 and to be sprayed onto the fire that caused glass 34 to break.

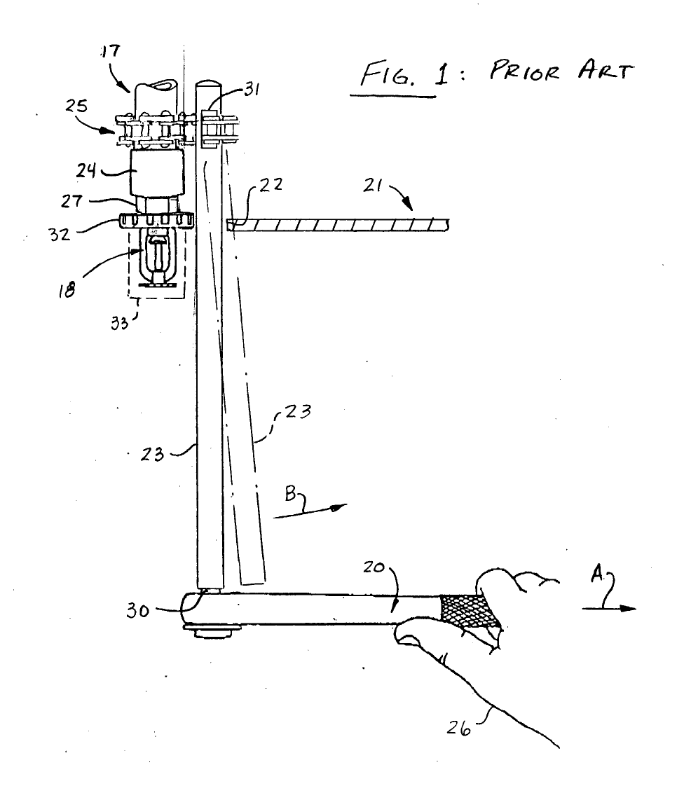

As illustrated in FIGS. 1, 15, and 16, when sprinkler head 18 is positioned in and extends into the opening 22A circumscribed by inner peripheral edge 22, skirt 32 ordinarily generally lies in about the same plane as the sheet rock, ceiling tile, etc. comprising the ceiling 21. Skirt 32 has a cylindrical shape. Edge 22 has a cylindrical shape. Opening 22A and edge 22 also typically, but not necessarily, have a cylindrical shape. At least a portion of skirt 32 usually extends into opening 22A. Skirt 32 is preferably centered in opening 22A such that the distance from skirt 32 to edge 22 is about one-half inch or less. The distance between skirt 32 and peripheral edge 22 can be more than or less than one-half inch, but at the point of closest approach of skirt 32 to edge 22, the distance from skirt 32 to edge 22 is usually about one-half inch.

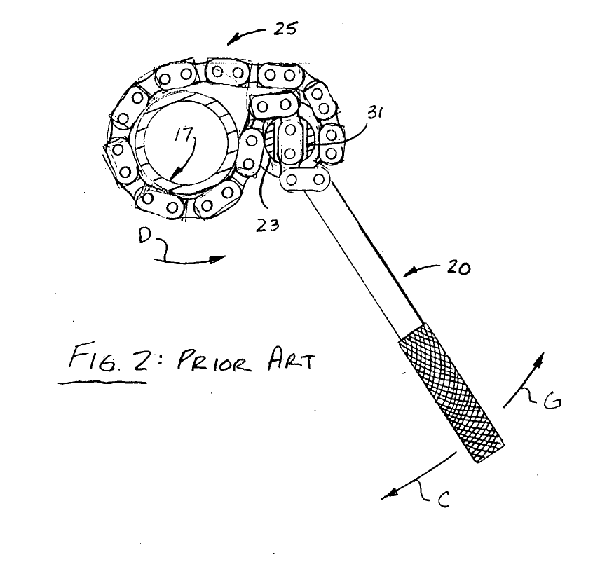

After a fire sprinkler system is installed, it is sometimes necessary to remove sprinkler head 18 from the distal end of conduit 17. This is typically accomplished with the tool and in the manner illustrated in FIGS. 1 and 2. The tool utilized includes an elongate cylindrical metal neck 23 that normally has a diameter of about one-half inch. An opening 31 is formed through the upper, or distal end, of neck 23. An endless chain 25 extends through opening 31. The lower, or proximate end, of neck 23 is shaped to receive the nose 30 of a wrench 20 so that a user can insert nose 30 in the lower end of neck 23 and can grasp and pull wrench 20 with his or her hand 26 to turn or rotate neck 23.

The length of endless chain 25 is sufficient so that when the chain is oriented to form the largest possible open loop extending outwardly from neck 23, the open loop can be moved upwardly over sprinkler head 18 and onto conduit 17 to the position on conduit 17 that is illustrated in FIG. 1. Chain 25 can, if desired, be moved upwardly over sprinkler head 18 to a position extending around cap 24, but this is not preferred because the pressure exerted by chain 25 on cap 24 can damage the adhesive securing cap 24 to conduit 17 and can cause fluid to leak out from conduit 17 between cap 24 and conduit 17. When the chain loop extends around conduit 17, wrench 20 is pivoted in the direction of arrow C to wrap the chain 25 around neck 23 and conduit 17 in the manner illustrated in FIG. 2. When wrench 20 is pulled in the direction of arrow C in FIG. 2 and is maneuvered to cause chain 25 to tightly engage conduit 17 in the manner illustrated in FIG. 2, then sprinkler head 18 can be grasped manually or with a tool and turned in a direction, indicated by arrow D, generally opposite that of the direction indicated by arrow C. As would be appreciated by those of skill in the art, chain 25 can also be looped over conduit 17 and wrench 20 can be displaced in a direction G opposite that of arrow C to again wrap chain 25 around neck 23 and around conduit 17. This would permit sprinkler head 18 to be turned in a direction opposite that of arrow D (and arrow G).

The “chain tool” described above with reference to FIGS. 1 and 2 can be utilized to facilitate the insertion of a sprinkler head 18 in the distal end of a conduit 17, or, to facilitate the removal of a sprinkler head 18 in the distal end of a conduit 17. The chain tool functions to stabilize conduit 17 by applying a turning torque that acts in a direction opposite the turning torque generated when an attempt is made to turn upper end 28 into or out of internally threaded opening 27A in member 27. The chain tool has, however, disadvantages.

One disadvantage of the chain tool is that wrench 20 must be moved so that neck 23 is canted in the manner indicated by dashed lines 23 in FIG. 1. This canting of neck 23 is necessary because it causes edges of the links in chain 25 to press into and engage conduit 17. Since the edges of the links in chain 25 tend to be small, care must be taken not so apply undue pressure to conduit 17 by tilting neck 23. Undue pressure will crack or otherwise damage conduit 17.

Another disadvantage of the chain tool is that when neck 23 is canted, abnormal twisting or torque forces are generated that act on the chain links. The chain links normally are not made to handle such forces, and tend to break.

A further important disadvantage of the chain tool is that neck 23 typically has a diameter of about one-half inch. This diameter is equal to the width of the normal space between skirt 32 and edge 22. When neck 23 is tilted in the direction of arrow B in the manner indicated by dashed lines 23 in FIG. 1, the upper portion of the neck 23 therefore bears against a portion of edge 22 and damages the dry wall or ceiling tile comprising ceiling 21. Such damages to ceiling 21 necessitate a repair operation. Such repair operations become especially time consuming and labor intensive when many sprinkler heads 18 are being removed or installed.

Still another important disadvantage of the chain tool is that it is difficult to control wrench 20 and it is a simple matter for a worker to move inadvertently wrench 20 in a direction (for example, the direction indicated by arrow A) that applies unwanted torque to neck 23 and chain 25. Such torque increases the likelihood that chain 25 or conduit 17 or ceiling 21 will be damaged.

Still a further disadvantage of the chain tool is that the length of chain 25 is not readily adjustable. The chain tool can only be adapted to fit different sizes of conduit 17 and heads 18 be removing and installing a new chain.

Yet another disadvantage of the chain tool is that the chain 25 typically only has a height of about ¼ of an inch. This relatively small height functions to apply forces generated by chain 25 against conduit 17 over a small area of conduit 17, increasing the likelihood conduit 17 will be broken or damaged.

Accordingly, it would be highly desirable to provide a method and apparatus that would facilitate the installation and removal of a sprinkler head from a fire sprinkler system, and that would reduce the risk that the fire sprinkler system or adjacent ceiling or other building structure would be damaged.

Therefore, it is a principal object of the instant invention to provide an improved system for removing and installing a sprinkler head.

A further object of the invention is to provide an improved system for removing and installing a sprinkler head from a fire sprinkler system, which system functions to more evenly distribute forces generated on a conduit in the sprinkler system during installation and removal of a sprinkler head.

Another object of the invention is to provide an improved sprinkler head removal and installation system that facilitates control of tool used to stabilize a conduit during removal of a sprinkler head from the conduit.

Still a further object of the invention is to provide an improved sprinkler head removal and installation system that minimizes the likelihood that a fire sprinkler system or building structure will be damaged during the installation or removal of a sprinkler head.

These and other, further and more specific objects and advantages of the invention will be apparent from the following detailed description of the invention, taken in conjunction with the drawings, in which:

FIG. 1 is a side elevation view illustrating a prior art chain tool being used to stabilize a conduit in a fire sprinkler system during removal from or installation on the conduit of a sprinkler head;

FIG. 2 is a top view of the tool of FIG. 1 further illustrating the mode of operation of the chain tool of FIG. 1;

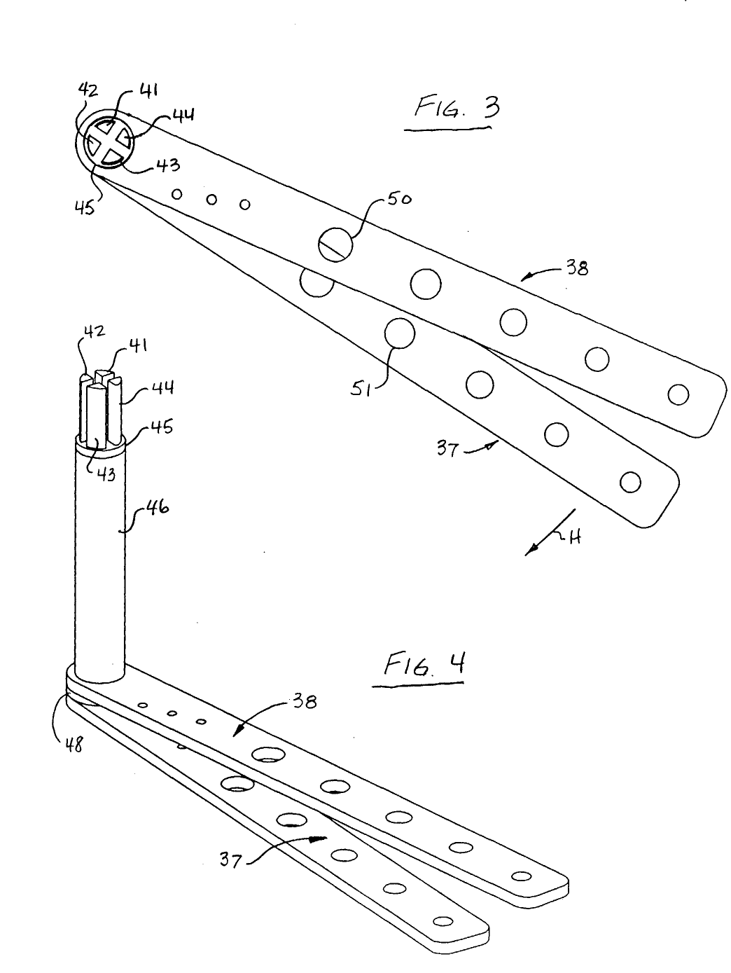

FIG. 3 is a top view illustrating the handle and neck of a tool constructed in accordance with the invention and used to stabilize a conduit during the installation and removal of a sprinkle head from the conduit;

FIG. 4 is a perspective view further illustrating the handle and neck of the tool of FIG. 3;

FIG. 5 is a perspective view illustrating the tool components of FIG. 4 further including the belt used to engage pliably and frictionally a conduit in a fire sprinkler system;

FIG. 6 is a partial perspective view illustrating a belt that can be utilized in the tool of FIG. 5;

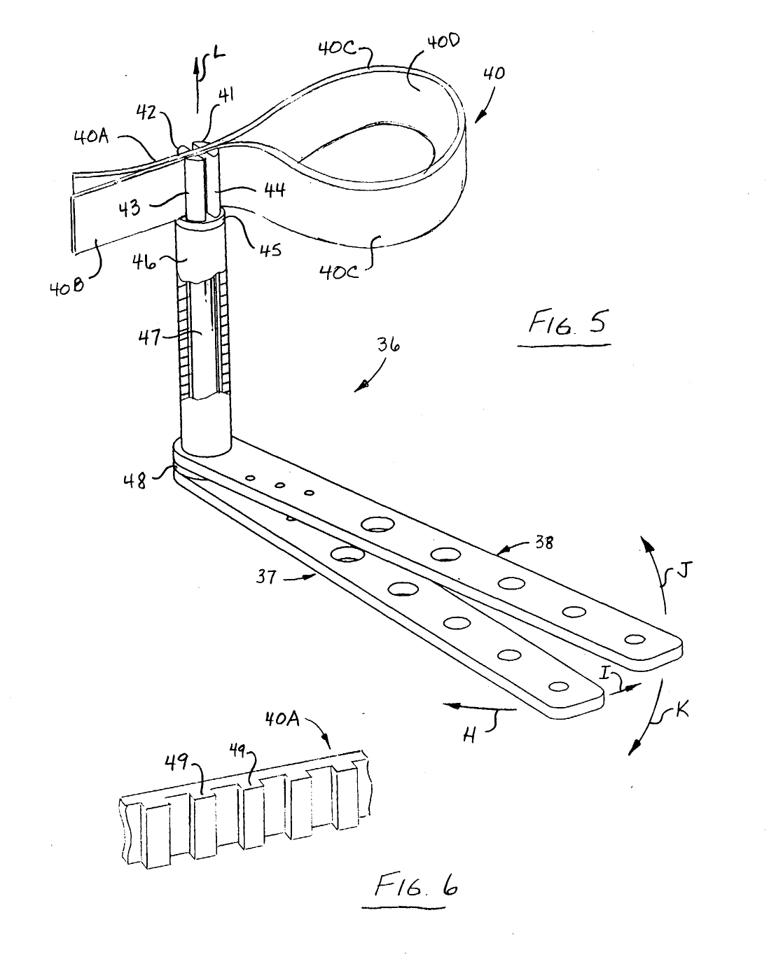

FIG. 7 is a top view illustrating the mode of operation of the tool of FIG. 5;

FIG. 8 is a top view further illustrating the mode of operation of the tool of FIG. 5;

FIG. 9 is a side elevation view illustrating a sprinkler head and the distal sprinkler-head-receiving-end of a conduit in a fire sprinkler system;

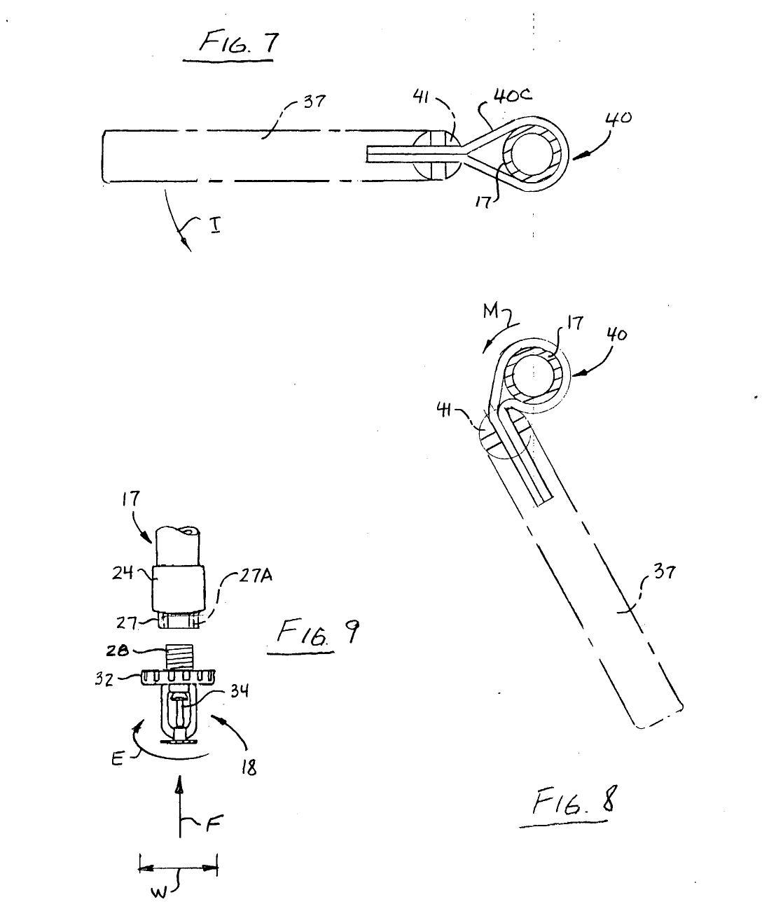

FIG. 10 is a perspective view illustrating another hand tool constructed in accordance with the principles of the invention;

FIG. 11 is a perspective view further illustrating the tool of FIG. 10;

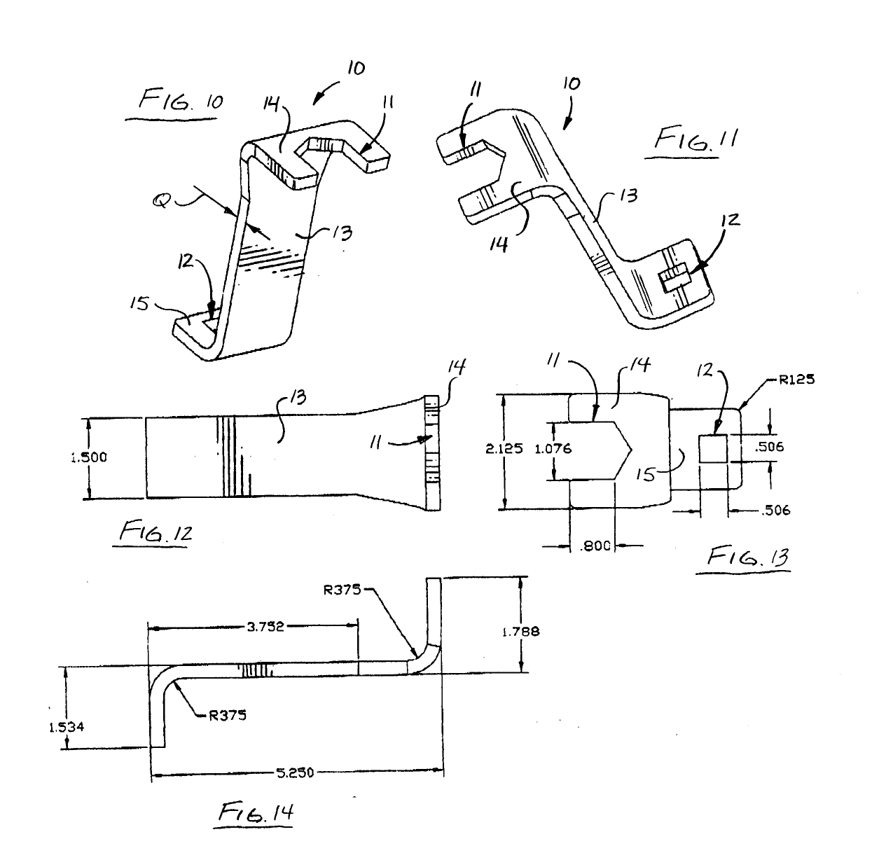

FIG. 12 is top view further illustrating the tool of FIG. 10;

FIG. 13 is a side view of the tool of FIG. 12 further illustrating construction details thereof;

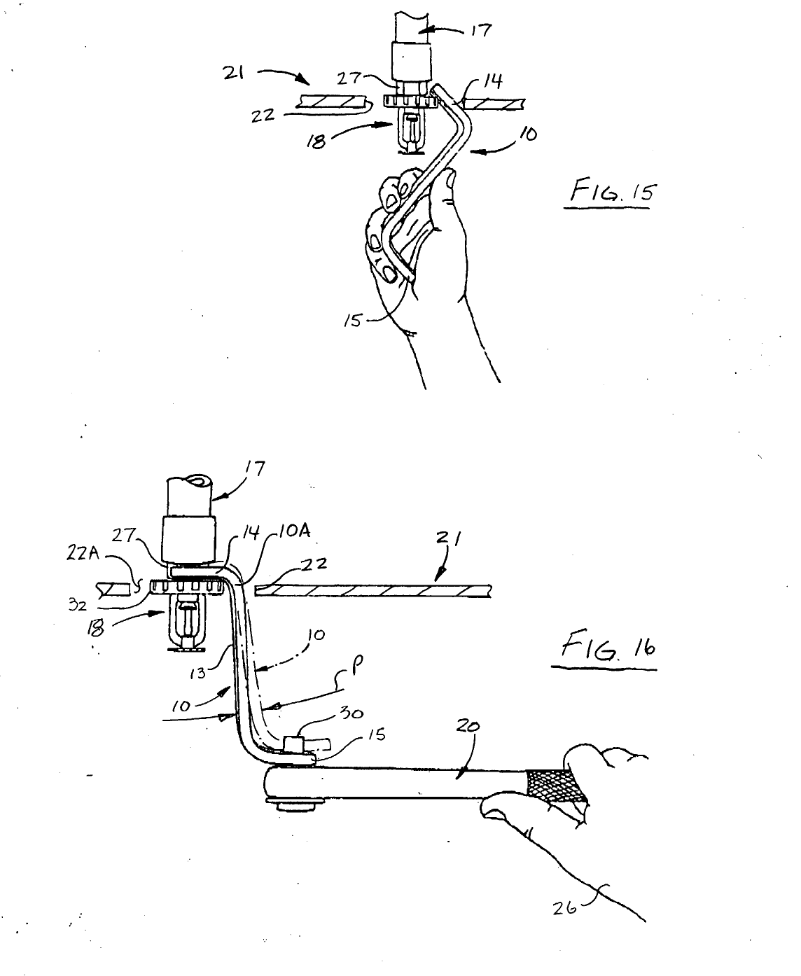

FIG. 14 is a front view illustrating the tool of FIG. 12;

FIG. 15 is a side elevation view illustrating the mode of operation of the tool of FIGS. 10 to 14 in removing a sprinkler head from a fire sprinkler system;

FIG. 16 is a side elevation view further illustrating the mode of operation of the tool of FIGS. 10 to 14.

Briefly, in accordance with my invention, I provide an improved method for removing a sprinkler head from a fire sprinkler system in a building structure. The fire sprinkler system includes an opening in the ceiling of a building structure. The opening includes an inner peripheral edge. The fire sprinkler system also includes a conduit having an internally threaded distal end, and a sprinkler head. The sprinkler head extends into the opening and has an externally threaded end turned into the internally threaded end, and, has a skirt spaced apart from the opening at the point of closest approach of the skirt to the inner peripheral edge of the opening a maximum distance of about one-half inch. The improved method includes the step of providing a tool. The tool includes an arm having a distal end shaped to engage the conduit; a proximate end shaped to engage an elongate wrench; and, a neck interconnecting the distal end and the proximate end and shaped and dimensioned such that when a portion of the neck is positioned intermediate the sprinkler head and the opening at the point of closest approach, the neck can be pivoted freely through an angle of at least fifteen degrees without contacting the inner peripheral edge of the opening and without contacting the sprinkler head. The method also includes the steps of engaging the conduit with the distal end of the tool; and, removing the sprinkler head from the conduit by turning the sprinkler head such that the externally threaded end turns out of the internally threaded distal end of the conduit.

In another embodiment of the invention, I provide an improved method for maintenancing a fire sprinkler system. The fire sprinkler system includes an opening in the ceiling, the opening including an inner peripheral edge; a conduit having an internally threaded distal end; and, a sprinkler head extending into the opening. The sprinkler head includes an externally threaded end turned into the internally threaded end; and, a skirt spaced apart from the opening at the point of closest approach of the skirt to the inner peripheral edge of the opening a maximum distance of about one-half inch. The improved method removes the sprinkler head from the conduit. The method includes the step of providing a tool. The tool has an arm. The arm includes a distal end shaped to engage the conduit; a proximate end shaped to engage an elongate wrench; a neck interconnecting the distal end and the proximate end and shaped and dimensioned such that when a portion of the neck is positioned intermediate the sprinkler head and the opening at the point of closest approach, the neck can be pivoted freely through an angle of at least fifteen degrees without contacting the inner peripheral edge of the opening and without contacting the skirt; and, a handle. The handle is connected to the proximate end and extends outwardly from the neck substantially normal to the neck. The handle includes a first member operable to move the distal end to engage the conduit, and a second member operable to stabilize the neck in a selected position while turning the distal end. The method also includes the step of engaging the conduit with the distal end of the tool by operating the first member to move the distal end to engage the conduit; and, by operating the second member to stabilize the neck in a selected position while the first member is moved. The method also includes the step of removing the sprinkler head from the conduit by turning the sprinkler head such that the externally threaded end turns out of the internally threaded distal end of the conduit.

Turning now to the drawings, which depict the presently preferred embodiments of the invention for the purpose of illustrating the practice thereof and not by way of limitation of the scope of the invention, and in which like reference characters refer to corresponding elements throughout the several views, FIGS. 3 to 5 illustrate a tool constructed in accordance with the principles of the invention, and including a neck having hollow cylindrical member 46 and having an upper distal end and a lower proximate end. The upper distal end of the neck includes cylindrical cap or member 45. The lower distal end of the neck includes cylindrical cap or member 48. Cylindrical shaft 47 extends between and is fixedly connected to members 45, 48. Shaft 47 rotatably extends inside and through hollow member 46. The tool includes a handle including elongate members 38 and 39. Member 38 is fixedly connected to the bottom of member 46 such that member 38 and member 46 move simultaneously when member 46 pivots or rotates about shaft 47.

At the proximate end of the neck, member 37 is fixedly connected to member 48.

At the distal end of the neck, parallel spaced apart fingers 41 to 44 are fixedly connected to and extend outwardly from member 45. One or more slots or other means for engaging a belt 40 can be formed at or in the distal end of the neck. Members 41 to 44 bound and define a pair of slots that are perpendicular to one another. The slots are sized so that each slot can, in the manner illustrated in FIG. 5, slidably receive the ends 40A, 40B of a pliable belt 40. Although each slot defined by members 41 to 44 may snugly or tightly grasp the ends 40A, 40B of a belt, ends 40A, 40B can be slidably removed from the slot. This enables ends 40A, 40B to be inserted in the slot at differing locations along each end so that the size of the loop 40C can be altered. Ends 40A, 40B typically are removed from a slot by pulling ends upwardly in the direction of arrow L in FIG. 5. Ends 40A, 40B are inserted in a slot by pressing the ends into the slot in a downward direction opposite that indicated by arrow L.

The ability to remove ends 40A, 40B from a slot defined by fingers 41 to 44 facilitates use of the tool 36 because a user can, if desired and appropriate, first loop belt 40 around conduit and then displace tool 36 upwardly and press the ends 40A, 40B into a slot that extends intermediate finger pair 41,42 and finger pair 43, 44, or, that extends (as is the case in FIG. 5) intermediate finger pair 41, 44 and finger pair 42, 43. If it is not practical to first position belt 40 around conduit 17 and then to press ends 40A, 40B intermediate fingers 41 to 44, then the ability to remove belt 40 from the distal end of tool 36 is important because it permits the ready installation of new belts, and because it permits the ready adjustment of the size of loop 40C. If desired, however, ends 40A and/or 40B can be permanently secured to the distal end of the neck of tool 36.

Belt 40 is preferably pliable, and can be elastic, although the rubber belt presently preferred is not elastic, or has only limited elasticity. The inner conduit-gripping surface 40D of belt 40 is also preferably, although not necessarily, at least somewhat tacky to facilitate the gripping of the exterior cylindrical surface of conduit 17 by belt 40.

FIG. 6 illustrates a belt 40A that can be in place of belt 40. The inner contuit-gripping surface of belt 40A is provided with a plurality of spaced apart feet 49 that facilitate the gripping by belt 40A of a conduit 17.

The shape and dimension of belt 40 can vary as desired, as can the shape and dimension of the various other components of tool 36. However, belt 40 is presently about one inch high and has a width of about one eighth of an inch.

Hollow member 46 has an outer diameter of about one-half inch. The neck of tool 36 is long enough to extend substantially vertically upwardly through an opening 22A (FIG. 16) in the same manner that neck 23 extends upwardly through an opening in FIG. 1, such that belt 40 extends around conduit 17 at about the same position on conduit 17 as does chain 25 in FIG. 1 and such that members 37 and 38 are positioned beneath ceiling 21 in the same manner as wrench 20 with members 37 and 38 generally horizontally oriented.

In use, tool 36 (FIG. 5) is provided. Loop 40C is passed over sprinkler head 18 until loop 40C extends around conduit 17 at about the same position on conduit 17 as chain 25 in FIG. 1. FIG. 7 illustrates loop 40 in this position on conduit 17. The user pivots member 38 in the direction of arrow H away from member 37 so that member 38 is not in registration with and is not parallel to member 37 and so that member 38 is pivoted away from member 37 through, for example, an angle of thirty degrees.

The user grasps and holds member 38 in fixed position with one hand. When the user moves member 38, member 38 moves simultaneously with hollow member 46. Member 46 rotates about shaft 47. Member 38 is important because it permits a user with one hand to control the vertical orientation of the neck of tool 36.

With the other hand, the user grasps member 37 and pivots member 37 in the direction of arrow I (FIGS. 5 and 7). As illustrated in FIGS. 7 and 8, when handle 37 is moved in the direction of arrow I, loop 40C is tightened about conduit 17 and a rotational force is generated on conduit 17 acting in the direction of arrow M. When the rotational force acts in the direction of arrow M, it counteracts any rotational force that acts in a direction opposite that of arrow M and that is generated when threaded upper end 28 is turned into (or, if appropriate, turned out of) internally threaded opening 27A. Consequently, tool 36 functions to product a counteracting force that tends to stabilize and protect conduit 17 when a sprinkler head 18 is being removed from or mounted on conduit 17, as the case may be.

As would be appreciated by those of skill in the art, loop 40C can also be positioned around conduit 17 and member 37 can be displaced in a direction H opposite that of arrow I to again wrap belt 40 around conduit 17. This would permit sprinkler head 18 to be turned in a direction opposite that of arrow H.

The protection provided by tool 36 is particularly important when head 18 is being removed, is tightly secured in opening 27A, and requires a significant turning torque to be applied to head 18 to loosen upper end 28 from internally threaded opening 27A. When head 18 is being removed from or mounted on conduit 17, head 18 can be turned manually, or, there are well known tools 33 (FIG. 1) that can be used to engage and turn upper end 28 into or out of internally threaded opening 27A. In FIGS. 7 and 8, for purposes of clarity, member 38 is omitted and only member 37 is shown in ghost outline.

One principal advantage of tool 36 is that it is less likely to damage conduit 17 than the chain tool of FIGS. 1 and 2. Another advantage of tool 36 is that member 38 offers a means to control unwanted lateral movements of the tool and therefore reduces the likelihood of damage to conduit 17 and to the adjacent ceiling 21. A further advantage of tool 36 is that there is no necessity to tilt the tool for the strap 40 to engage conduit 17. As noted, in use the chain tool must be tilted so that edges of the chain dig into and engage conduit 17. Still another advantage of tool 36 is that the size of loop 40C is adjustable. Still a further advantage of tool 36 is that belt or strap 40 can be looped around conduit 17 prior to positioning the ends 40A, 40B in the distal end of the neck of the tool.

FIGS. 10 to 14 illustrate another tool constructed in accordance with the invention and generally indicated by reference character 10. Tool 10 includes a distal end 14 provided with opening 11 shaped and dimensioned to engage an opposing spaced apart pair of outer peripheral faces of hex nut member 27 (in the same manner that a monkey wrench engages a hex nut to turn the nut). Tool 10 also includes a proximate end 15 provided with an opening 12 shaped and dimensioned to receive the nose 30 of a wrench 20. Tool 10 is fabricated from a metal panel that is about one-quarter of an inch thick. The thickness of tool 10 is important and is preferably less than about one-half of an inch. Since the thickness of tool 10 is less than the distance between skirt 32 and inner peripheral edge 22, after tool 10 is inserted to the position illustrated in FIG. 16, tool 10 can be tilted through an angle, indicated by arrows P, without contacting edge 22 or skirt 32. Angle P is fifteen degrees, preferably thirty degrees, and most preferably forty-five degrees. The small thickness, indicated by arrows Q in FIG. 10, of tool 10 reduces or eliminates the risk that ceiling 21 or sprinkler head 18 will be damaged during use of the tool. If desired, the thickness of tool 10 can vary at different points on the tool. It is important, however, that the thickness of the portion of tool 10 that extends through opening 22A is less than the minimum distance from skirt 32 to inner peripheral edge 22. The thickness Q of at least the portion 10A of tool 10 extending between skirt 32 and edge 22 is typically at least 10% less than the smallest distance from skirt 32 to edge 22, is preferably at least 25% less than the smallest distance from skirt 32 to edge 22, and is most preferably at least 50% less than the smallest distance from skirt 32 to edge 22. In FIGS. 10 to 16, the thickness of tool 10 at all points on tool 10 is substantially the same, as can be seen in FIG. 14.

Use of tool 10 is illustrated in FIGS. 15 and 16. In FIG. 15 the distal end 14 of tool 10 is threaded between skirt 32 and edge 22 so opening 11 engages hex nut member 27. FIG. 16 illustrates the position of distal end 14 after it is threaded between skirt 32 and edge 22 to a position in which opening 11 engages hex-nut member 27 such that tool 10 can be used to apply a rotational force to hex nut member 27. The nose 30 of a wrench 20 is extended through and positioned in opening 12 of proximate end 15 in the manner illustrated in FIG. 16 The user grasps wrench 20 with his hand 26, grasps sprinkler head 18 with the other hand (or with a tool), and turns sprinkler head 18 in a direction which causes end 28 to unthread from opening 27A in hex nut member 27. If desired, the user engages head 18 with a tool that facilitates the removal of member 28 from opening 27A. When the user applies a rotational force to head 18 to turn end 28 out of opening 27A, the user uses his hand 26 to apply a force to wrench 20 that in turn applies via tool 10 a rotational force to hex nut member 27 that acts in a direction opposite the direction of the rotational force being applied to head 18 to remove end 28 from opening 27A. Consequently, the force applied by the user to wrench 20 and tool 10 and hex nut member 27 counteracts the force being applied to head 18 and prevents the force applied to head 18 from generating a rotational torque force on conduit 17 that could damage conduit 17. After head 18 is removed or is sufficiently loosened from hex nut member 27, tool 10 is removed from hex nut member 27 and opening 22A.

One advantage of tool 10 is that it is less likely to damage conduit 17 than the chain tool of FIGS. 1 and 2. Tool 10, unlike the chain tool, does not engage a plastic portion of conduit 17. Another advantage of tool 10 is that member 38 offers a means to compensate for unwanted lateral movements of the tool and therefore reduces the likelihood of damage to conduit 17 and to the adjacent ceiling 21. A further advantage of tool 10 is that there is no necessity to tilt the tool for the strap 40 to engage conduit 17. Opening 11 automatically engages hex nut member 27. As noted, in use the chain tool must be tilted so that edges of the chain dig into and engage conduit 17.

Having described my invention in such terms as to enable those of skill in the art to make and practice it, and having described the presently preferred embodiments thereof,

I claim:

1. In a fire sprinkler system including
an opening in the ceiling, the opening including an inner peripheral edge,
a conduit having an internally threaded distal end, and
a sprinkler head extending into the opening and having
an externally threaded end turned into the internally threaded end, and,
a skirt spaced apart from said opening at the point of closest approach of the skirt to the inner peripheral edge of the opening a maximum distance of about one-half inch,
a method for removing the sprinkler head from the conduit, said method including the steps of providing
(a) a tool including an arm having
(i) a distal end shaped to engage the conduit,
(ii) a proximate end shaped to engage an elongate wrench,
(iii) a neck interconnecting said distal end and said proximate end and shaped and dimensioned such that when a portion of said neck is positioned intermediate the sprinkler head and the opening at the point of closest approach, said neck can be pivoted freely through an angle of at least fifteen degrees without contacting the inner peripheral edge of the opening and without contacting the sprinkler head;
(b) engaging the conduit with the distal end of the tool; and,
(c) removing the sprinkler head from the conduit by turning the sprinkler head such that the externally threaded end turns out of the internally threaded distal end of the conduit.

2. In a fire sprinkler system including
an opening in the ceiling, the opening including an inner peripheral edge,
a conduit having an internally threaded distal end, and
a sprinkler head extending into the opening and having
an externally threaded end turned into the internally threaded end, and,
a skirt spaced apart from the opening at the point of closest approach of the skirt to the inner peripheral edge of the opening a maximum distance of about one-half inch,
a method for removing the sprinkler head from the conduit, said method including the steps of providing
(a) a tool including an arm having
(i) a distal end shaped to engage the conduit,
(ii) a proximate end shaped to engage an elongate wrench,
(iii) a neck interconnecting said distal end and said proximate end and shaped and dimensioned such that when a portion of said neck is positioned intermediate the sprinkler head and the opening at the point of closest approach, said neck can be pivoted freely through an angle of at least fifteen degrees without contacting the inner peripheral edge of the opening and without contacting the skirt,
(iv) a handle connected to said proximate end and extending outwardly from said neck substantially normal to said neck, said handle including
(i) a first member operable to move said distal end to engage the conduit, and
(ii) a second member operable to stabilize said neck in a selected position while turning said distal end;
(b) engaging the conduit with the distal end of the tool by
(i) operating said first member to move said distal end to engage the conduit, and,
(ii) operating said second member to stabilize said neck in a selected position while said first member is moved; and,
(c) removing the sprinkler head from the conduit by turning the sprinkler head such that the externally threaded end turns out of the internally threaded distal end of the conduit.
